(19) United States
(12) Patent Application Publication
(10) Pub. No.: US 2006/0029357 A1
(43) Pub. Date: Feb. 9, 2006

(54) Method of processing optical fiber

(75) Inventors: Masahiro Fushimi, Tokyo (JP); Atsushi Ichikawa, Ibaraki-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/190,897

(22) Filed: Jul. 28, 2005

(30) Foreign Application Priority Data
Aug. 3, 2004 (JP) 2004-226339

(51) Int. Cl. G02B 6/00

(52) U.S. Cl. 385/147

(57) ABSTRACT

A method of processing an optical fiber having a first facet and a second facet is provided. The method includes the steps of applying a photo-curing material which is optically transparent and hardens under light of a predetermined wavelength, to a region on the first facet at least including an entirety of a core in a substantially uniform thickness, irradiating the light of the predetermined wavelength from the second facet through an inside of the optical fiber, so as to expose only a portion of the photo-curing material applied to the core on the first facet, and developing the first facet to create a level gap between the core and a clad on the first facet.

### INCORPORATION BY REFERENCE

This application claims priority of Japanese Patent Application No. 2004-226339, filed on Aug. 3, 2004, the entire subject matter of the application being incorporated herein by reference.

### BACKGROUND OF THE INVENTION

The present invention relates to a method of processing an optical fiber employed in an optical communication apparatus.

An optical communication apparatus for transmitting light carrying information to an optical communication network has been widely used. Such an optical communication apparatus includes as a laser diode (LD), a lens that converges light from the LD, and an optical fiber. An optical communication module that serves as an ONU (Optical Network Unit), through which the optical fiber communication is introduced into a subscriber's house, generally includes a photoreceptor and a WDM (Wavelength Division Multiplex) filter that separates light of different wavelengths, for performing interactive communication in which a sing optical fiber is used for both transmission and reception in common.

In such an optical communication module, signal light from the LD has to be introduced to a generally central portion of a core of the optical fiber, so as to transmit or receive the signal light through the optical fiber. In other words, the LD has to be precisely positioned with respect to the core of only a few microns in diameter, of the optical fiber. Japanese Patent Provisional Publication No. 2002-286977 discloses a technique of finishing a facet of the core in a protruding shape on a facet of the optical fiber, to facilitate the distinction of the core and clad on the facet of the optical fiber, to thereby simplify the positioning process, at the same time improving the precision thereof.

The method of processing an optical fiber disclosed in the publication includes applying a resist to a facet of the optical fiber, exposing a portion of the resist applied to an end face of the core, developing the facet of the optical fiber, and performing an etching on the facet of the optical fiber. In other words, the publication proposes removing by etching the resist provided on the facet of the optical fiber, except the portion that has been hardened by the exposure and development process, so as to leave a protruding portion on the facet of the optical fiber. As is already apparent, the method disclosed in the publication requires a plurality of steps to make the core protrude on the facet of the optical fiber. Therefore, the processing method according to the publication has a drawback that many working steps are required, and thus the manufacturing cost is inevitably increased.

### SUMMARY OF THE INVENTION

The present invention is advantageous in that it provides a method of processing an optical fiber that allows finishing an end face of a core in a protruding shape, on a facet of the optical fiber constituting an optical communication module, in a simplified manner and at a lower cost.

According to an aspect of the present invention, there is provided a method of processing an optical fiber having a first facet and a second facet. The method includes the steps of applying a photo-curing material which is optically transparent and hardens under light of a predetermined wavelength, to a region on the first facet at least including an entirety of a core in a substantially uniform thickness, irradiating the light of the predetermined wavelength from the second facet through an inside of the optical fiber, so as to expose only a portion of the photo-curing material applied to the core on the first facet, and developing the first facet to create a level gap between the core and a clad on the first facet.

By the method thus arranged, it is possible to form a hardened film of the photo-curing material only on the surface of the core on the first facet. Accordingly, a level gap can be created between the core and the clad on the first facet, without the need of performing an etching process.

Optionally, in the applying step, the photo-curing material may be applied to an entire region of the first facet.

Still optionally, a height of the level gap may be determined depending on a thickness of the photo-curing material applied to the first facet in the applying step.

In a particular case, the thickness of the photo-curing material may be determined depending on a type of applying technique employed in the applying step.

In a particular case, the thickness of the photo-curing material may be determined depending on viscosity of the photo-curing material employed in the applying step.

Optionally, a refractive index of the photo-curing material may be different from that of the clad of the optical fiber.

In a particular case, the refractive index of the photo-curing material may be lower than that of the clad of the optical fiber.

According to another aspect of the invention, there is provided an optical communication apparatus, which is provided with a light source that irradiates light carrying information, and an optical fiber including a light receiving facet to which the light irradiated by the light source is introduced, and a level gap having a predetermined height between a core facet and a clad facet on the light receiving facet. The level gap is formed by the above mentioned method of processing an optical fiber. The optical communication apparatus is further provided with a condenser lens located on an optical path of the light and between the light source and the light receiving facet, so as to converge the light to form a spot on the light receiving facet, a moving system that moves the spot formed by the condenser lens with respect to the light receiving facet, a photo detector that receives a portion of the light produced through the light receiving facet, and a controller that controls the moving system. In this structure the level gap is formed so that the light incident on the light receiving facet is diffracted, and the controller operates the moving system such that an intensity distribution of the light received by the photo detector matches a reference distribution.

Optionally, the moving system may include an actuator that moves the condenser lens so that the spot is moved on the light receiving facet of the optical fiber.

### BRIEF DESCRIPTION OF THE ACCOMPANYING DRAWINGS

FIG. 1 is a schematic perspective view showing an optical fiber processed by a method of processing an optical fiber according to an embodiment of the present invention;

FIGS. 2A to 2D are schematic side views of the optical fiber for explaining the steps of the method of processing an optical fiber according to the embodiment; and

FIG. 3 is a schematic diagram showing a configuration of an optical communication module including the optical fiber processed by the method of processing an optical fiber according to the embodiment.

### DETAILED DESCRIPTION OF THE EMBODIMENTS

Hereinafter, an embodiment according to the invention is described with reference to the accompanying drawings.

As described in detail below, an optical fiber 3 is manufactured in accordance with a method of processing an optical fiber according to the embodiment. The optical fiber 3 processed by the method according to the embodiment is intended for use in an optical communication module (i.e., an optical communication apparatus), so as to serve to transmit signal light from an LD. The essence of the method of processing an optical fiber according to the embodiment lies in finishing a core of an optical fiber in a protruding shape with respect to a clad, i.e. forming a level gap, on a facet of the optical fiber to which light from the LD is introduced. Such processing allows clearly defining a difference in an optical property between the core and the clad, on the facet to which the signal light is introduced. Accordingly, in the optical communication module implemented with the optical fiber processed by the method according to the embodiment, the positioning of the LD with respect to the optical fiber can be performed with high precision, based on the difference in an optical property defined by the level gap.

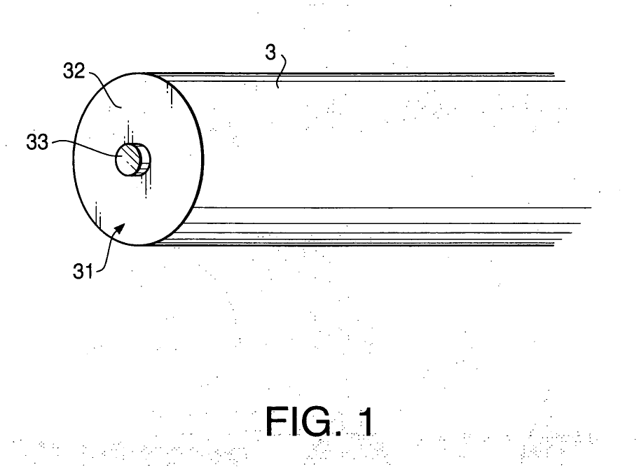

FIG. 1 illustrates the optical fiber 3 processed by the processing method according to the embodiment. As shown in FIG. 1, the optical fiber 3 includes a clad 32 and a core 33. The optical fiber 3 is finished such that the core 33 protrudes by a predetermined height (level gap) along an optical axis of the optical fiber 3, from a first facet 31. Such protruding portion of the core 33 is formed such that an end face of the core 33 becomes generally parallel to a facet of the clad 32.

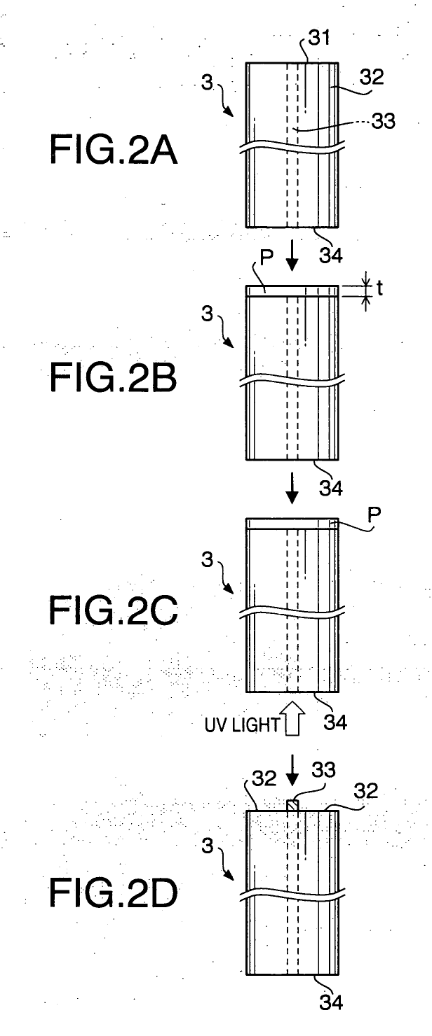

FIGS. 2A to 2D are schematic side views of the optical fiber for explaining the steps of the method of processing an optical fiber according to the embodiment. As shown in FIG. 2A, the optical fiber 3 includes a second facet 34, located opposite to the first facet 31.

Referring to FIG. 2A, the optical fiber 3 is fixed by a fixing tool (not shown), before starting the processing. In FIG. 2B, the optical fiber 3 undergoes a coating process in which a photo-curing resin P is applied to the entire region of the first facet 31 in a generally uniform thickness. The photo-curing resin herein employed is a resin having both light transmitting and UV-curing natures, such as an epoxy resin, an acrylate resin or a silicone resin. For applying the photo-curing resin P to the entire region of the first facet 31 in a generally uniform thickness, a technique may be employed such as spreading the photo-curing resin P dropped onto the first facet 31 by a spin coater (spin coating), dipping the first facet 31 in a solution of the photo-curing resin P (dip coating), and spraying the photo-curing resin P toward the first facet 31 (spray coating).

The film thickness t of the photo-curing resin P applied in the coating process shown in FIG. 2B turns into the height of the level gap between the end face of the core 33 and the facet of the clad 32 on the first facet 31, upon completing the process. Accordingly, adjusting the film thickness t results in forming the level gap of a desired height on the first facet 31. The film thickness t can be adjusted simply by selecting one of the foregoing coating methods. Further, in each of those coating methods, modifying a coating condition allows adjusting the film thickness t more precisely. When employing the spin coating for example, the film thickness t can be increased or decreased by changing the rotating speed. Moreover, controlling the viscosity of the photo-curing resin P also leads to adjusting the film thickness t. The modification of the condition may include changing the lifting speed of the optical fiber out of the photo-curing material solution in the dip coating, or change the mixing ratio of the compressed air and the photo-curing material solution, in the spray coating.

Once the photo-curing resin P has been uniformly coated all over the first facet 31, a level gap forming process is carried out. As shown in FIG. 2C, in the level gap forming process UV light is irradiated from the side of the second facet 34. The UV light enters the second facet 34, and reaches the photo-curing resin P coated on the first facet 31 through the core 33. When the UV light is thus irradiated from the side of the second facet 34 instead of from the side of the first facet 31, the clad 32 serves as a mask. Accordingly, because of the structure of the optical fiber wherein the core 33 and the clad 32 are entirely in close contact with each other, only a portion of the photo-curing resin P present in a region precisely corresponding to the core 33 on the first facet 31 can be selectively exposed. The region corresponding to the core 33 means a portion delimited by the diameter of the core 33 and the thickness t of the photo-curing resin P coated on the core 33.

The irradiation time of the UV light is determined such that the photo-curing resin P in the region corresponding to the core 33 is sufficiently exposed. After the exposure, a development process is carried out, through which the unexposed portion of the photo-curing resin P, i.e. the photo-curing resin P coated in a region corresponding to the clad 32, is dissolved and removed.

FIG. 2D depicts the state of the optical fiber 3 after the development process. In view of the optical fiber 3 shown in FIG. 2D, it is explicitly understood that the irradiation of the UV light from the side of the second facet 34 leaves only the portion of the photo-curing resin P in the region corresponding to the core 33 generally in a column shape that includes the core 33 as its bottom face, in other words forms a level gap between the end face of the core 33 and the facet of the clad 32, on the first facet 31.

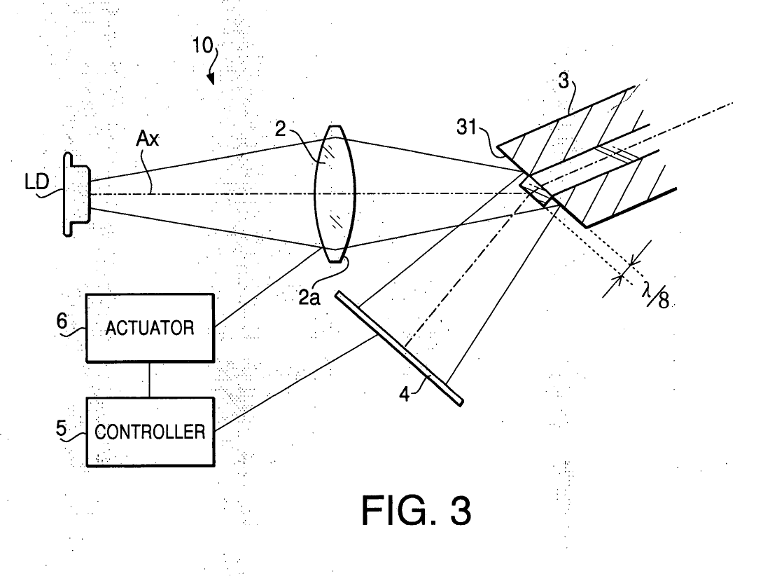

Now, incorporating the optical fiber 3, provided with a protruding portion formed on the first facet 31 by the method of processing according to the embodiment, in an optical communication module 10 (see FIG. 3) such that the first facet 31 serves for receiving the light from the LD, allows the optical communication module to constantly perform a positioning process of adjusting the incident position on the first facet 31 for the light from the LD, to the center of the core 33.

FIG. 3 is a schematic diagram showing a configuration of the optical communication module 10 implemented with the optical fiber 3. The optical communication module 10 includes, in addition to the optical fiber 3, the LD, a condenser lens 2, a photo detector 4, a controller 5 and an actuator 6. In the practical use of the optical communication module 10, an incident angle at the optical fiber 3, of an optical beam output by the LD and introduced to the optical fiber 3 via the condenser lens 2, is extremely small. However, for the sake of explicitness of the description, FIG. 3 illustrates a much wider incident angle than the actual angle. The optical communication module 10 may serve as an ONU that introduces the optical fiber communication into a subscriber's house. The optical communication module 10 may be configured to support an interactive WDM communication utilizing an optical fiber for transmitting an upstream signal having a wavelength of for example 1.3 μm, and for receiving a downstream signal having a wavelength of for example 1.5 μm.

The laser diode LD working as the light source of transmission signal light is a surface emitting laser, which can be used to modulate light according to information to be transmitted. The optical fiber 3 is installed such that the first facet 31 confronts the condenser lens 2. The first facet 31 (light receiving facet 31 ) of the optical fiber 3 is cut off along a plane that is not orthogonal to the extension of the optical fiber 3. Also, each component is configured such that the light from the LD is introduced to the light receiving facet 31 at an incident angle other than 0 degree. With such configuration, the optical communication module 10 leads the reflecting light from the light receiving facet 31 to the photo detector 4, without employing a deflecting component. In addition, a reference axis AX shown by a dash-dot line in FIG. 3 is the center axis serving as the reference for positioning, in the optical communication module 10.

The light emitted by the LD is converged by the condenser lens 2 so as to be incident upon the light receiving facet 31 of the optical fiber 3, thus to create a spot. The condenser lens 2 is granted a power that can make a spot having a larger diameter than the end face of the core 33.

The optical fiber 3 is processed by the processing method according to the embodiment, such that the height of the level gap formed on the light receiving facet 31 becomes smaller than λ(4n). Here, λ represents a wavelength of the incident light, and n represents a refractive index of the medium. Such configuration of the optical fiber 3 causes diffraction when a light beam converged so as to create a spot having a slightly larger diameter than the core 33 is incident upon a region including the core 33 and a portion of the clad 32. In this embodiment, the level gap is determined as λ/8, so as to attain highest diffraction efficiency of the diffracted light created out of the light reflected by the core 33 and the clad 32.

Accordingly, the light reflected by the light receiving facet 31 and incident upon the photo detector 4 forms a diffraction pattern. The photo detector 4 detects a light intensity distribution according to the diffraction pattern. Here, the light incident upon the photo detector 4 includes the light reflected by the end face of the core 33 and having a relatively high intensity. Therefore, it is preferable to employ a photo-curing resin P having a lower refractive index than the clad 32, in the processing method according to the embodiment. Since such a configuration allows restraining the intensity of the reflected light, the photo detector 4 can precisely detect fine fluctuation of the diffraction pattern (i.e., the light intensity distribution).

The controller 5 performs a negative feedback control so that the center of the spot created on the light receiving facet 31 is positioned substantially at the center of the end face of the core 33, based on the light intensity distribution detected by the photo detector 4. More specifically, the controller 5 drives the condenser lens 2 through the actuator 6 until the detected light intensity distribution matches a reference distribution, to thereby move the position of the spot on the light receiving facet 31. The reference distribution herein means a state in which the center of the spot coincides with the center of the end face of the core 33. That is, the reference distribution corresponds to a light intensity distribution obtained when a highest coupling efficiency is achieved.

As described above, employing an optical fiber processed by the method of processing an optical fiber according to the foregoing embodiment allows precisely adjusting an incident position of light on a light receiving facet (the first facet 31) to the center of the core 33.

As described above, the present invention provides a method of processing a facet of a core in a protruding shape through simplified steps and in a shorter time, by skipping an etching process which has conventionally been an indispensable step. Also, eliminating the etching process results in further reduction in manufacturing cost.

Therefore, the method allows reducing the labor and cost required for the processing by the amount required by the etching process. In the conventional optical fiber processing method, the etching process is a step that requires special care in precision and a considerable duration in time that cannot be spared. In this sense, skipping the etching process is particularly beneficial in improving the processing efficiency of the optical fiber, and hence the production efficiency of the optical communication module itself in which the optical fiber is suitably employed.

The present invention has been described in details based on the preferred embodiment thereof, however it is to be understood that various modifications may be made without departing from the scope of the present invention. To cite a few examples, while the photo-curing resin P is applied to an entire surface of the first facet 31 in the foregoing embodiment, the level gap can be duly formed provided that the photo-curing resin P is applied to a portion of the first facet 31 at least including an entirety of the core 33.

Also, when incorporating the optical fiber 3 processed by the method according the embodiment in an optical communication module, the optical fiber may be directly fixed to a light emitting device, according to a method disclosed in the aforementioned cited publication (No. 2002-286977).

What is claimed is:

1. A method of processing an optical fiber having a first facet and a second facet, comprising the steps of:
applying a photo-curing material which is optically transparent and hardens under light of a predetermined wavelength, to a region on the first facet at least including an entirety of a core in a substantially uniform thickness;
irradiating the light of the predetermined wavelength from the second facet through an inside of the optical fiber, so as to expose only a portion of the photo-curing material applied to the core on the first facet; and
developing the first facet to create a level gap between the core and a clad on the first facet.

2. The method according to claim 1, wherein in the applying step, the photo-curing material is applied to an entire region of the first facet.

3. The method according to claim 1, wherein a height of the level gap is determined depending on a thickness of the photo-curing material applied to the first facet in the applying step.

4. The method according to claim 3, wherein the thickness of the photo-curing material is determined depending on a type of applying technique employed in the applying step.

5. The method according to claim 3, wherein the thickness of the photo-curing material is determined depending on viscosity of the photo-curing material employed in the applying step.

6. The method according to claim 1, wherein a refractive index of the photo-curing material is different from that of the clad of the optical fiber.

7. The method according to claim 6, wherein the refractive index of the photo-curing material is lower than that of the clad of the optical fiber.

8. An optical communication apparatus, comprising:
a light source that irradiates light carrying information;
an optical fiber including a light receiving facet to which the light irradiated by the light source is introduced, and a level gap having a predetermined height between a core facet and a clad facet on the light receiving facet, the level gap being formed by the method according to claim 1;
a condenser lens located on an optical path of the light and between the light source and the light receiving facet, so as to converge the light to form a spot on the light receiving facet;
a moving system that moves the spot formed by the condenser lens with respect to the light receiving facet;
a photo detector that receives a portion of the light produced through the light receiving facet; and
a controller that controls the moving system;
wherein:
the level gap is formed so that the light incident on the light receiving facet is diffracted; and
the controller operates the moving system such that an intensity distribution of the light received by the photo detector matches a reference distribution.

9. The optical communication apparatus according to claim 8, wherein the moving system includes an actuator that moves the condenser lens so that the spot is moved on the light receiving facet of the optical fiber.
